(19) United States
(12) Patent Application Publication
(10) Pub. No.: US 2015/0174704 A1
(43) Pub. Date: Jun. 25, 2015

(54) VOC Exempt Brazing Binder System

(71) Applicant: Lucas-Milhaupt, Inc., Cudahy, WI (US)

(72) Inventor: Matthew M. Kasper, Oak Creek, WI (US)

(21) Appl. No.: 14/577,345

(22) Filed: Dec. 19, 2014

Related U.S. Application Data
(60) Provisional application No. 61/919,506, filed on Dec. 20, 2013.

(51) Int. Cl. B23K 35/36; B23K 35/02

(52) U.S. Cl. CPC B23K 35/3613; B23K 35/025

(57) ABSTRACT

By blending a brazing alloy, preferably a Cu, P, Sn, and Ni alloy, with a binder system (and in some cases other blended alloys), the invention includes several superior brazing binder systems. The brazing binder system is formed suitable for all the joint configurations commonly found in heat transfer equipment. The inventive binder system product includes an ultra low VOC coating, low VOC coating, and VOC exempt brazing binder system. The binder system may be sprayed on, brushed on, or applied using standard paste dispensing equipment.

### CROSS-REFERENCE TO RELATED APPLICATION

This application claims priority from U.S. Provisional Patent Application Ser. No. 61/919,506, filed on Dec. 20, 2013, the entirety of which is expressly incorporated by reference herein.

### BACKGROUND OF THE INVENTION

1. Field of the Invention

The present invention relates in general to the field of brazing paste. More particularly, the present invention relates to formulation of brazing paste with reduced carbon residue. The present invention also relates to an increased suspension of alloy particles in the brazing paste. Specifically, a preferred embodiment of the present invention relates to an ultra-low volatile organic compound (VOC) coating through the use of VOC exempt solvents. Throughout this disclosure the term “brazing paste” is used interchangeably with “brazing binder system”.

2. Discussion of the Related Art

VOCs are a large group of organic chemicals that include any compound of carbon (excluding carbon monoxide, carbon dioxide, carbonic acid, metallic carbides or carbonates, and ammonium carbonate) and that participate in atmospheric photochemical reactions. VOCs are of interest in part because they contribute to ozone formation. Ozone is formed from chemical reactions involving airborne VOCs, airborne nitrogen oxides, and sunlight. VOCs are also of interest because many individual VOCs are known to be harmful to human health. Adverse health effects are well known from VOC exposure, but vary by the exact pollutant. While VOCs may be emitted from traditional brazing operations and component manufacture, they are also emitted from other sources such as motor vehicle emissions, chemical manufacturing facilities, refineries, factories, consumer and commercial products, and natural (biogenic) sources (mainly trees) as shown in the graph below. As a result, many manufacturing companies are taking active steps to reduce VOCs from their manufacturing processes and commercial products.

Brazing products are commonly known to contribute to VOC emissions. Brazing alloys are often pre-placed in a slurry which forms a paste. Brazing paste consists of brazing alloy powder, a binder, and quite often a flux. Although brazing pastes are generally more expensive than brazing preforms, they are preferable for some applications due to the ease of pre-application.

A previously recognized problem with brazing pastes has been that the flux residues of brazing pastes are corrosive and therefore their removal after brazing is essential. Residues formed are similar to those generated in other brazing operations and may be removed by soaking in hot water (>40° C. for 30 minutes), soaking in 10% sulfuric acid, or by mechanical removal (e.g., grit blasting). Brazing pastes also often leave a ‘footprint’ or mark of carbon on the component that is difficult to remove after brazing. The use of VOCs in brazing paste also poses a health hazard and shipping issue as many states have heavily regulated the use of VOC-containing products. Also, due to the combination of many different chemicals when formulating a brazing paste, achieving a uniform mixture can be difficult.

What is needed therefore is a VOC-exempt, quick drying, to carbon residue, more uniform brazing paste. Heretofore, these requirements have not been fully met without incurring various disadvantages.

### SUMMARY AND OBJECTS OF THE INVENTION

By way of summary, the present invention is directed to a method of forming a brazing binder system comprising the steps of providing a Volatile Organic Compound “VOC” exempt solvent in a range of 88.00% to 96.00% of total mass of the brazing paste, combining a hydrogenated styrene ethylene ethylene propylene styrene/styrene ethylene propylene styrene block copolymer in a range of 3.00% to 8 00% of total mass of the brazing paste, adding a hydrocarbon resin in a range of 1.00% to 4.00% of total mass of the brazing paste, and mixing the brazing paste into a homogeneous mixture.

The VOC exempt solvent may include a parachlorobenzotrifluoride and the hydrogenated styrene ethylene ethylene propylene styrene/styrene ethylene propylene styrene block copolymer may include block segments of styrene monomer units and hydrogenated conjugated diene monomer units. The hydrogenated styrene ethylene ethylene propylene styrene/styrene, ethylene propylene styrene block copolymer may include a styrene content of at least 18% weight.

The production of the hydrocarbon resin may include polymerization and hydrogenation of pure monomer hydrocarbon feedstocks. When producing the brazing paste mixture, the process may begin by mixing the brazing paste into a homogeneous mixture and adding the VOC-exempt solvent into to an impermeable container and Cowles blade. Next, the hydrogenated styrene ethylene ethylene propylene styrene/styrene ethylene propylene styrene block copolymer may be added to the impermeable container. The mixture may be combined with the Cowles blade while adding the hydrocarbon resin to the impel useable container and continuing to mix until the hydrogenated styrene ethylene ethylene propylene styrene/styrene ethylene propylene styrene block copolymer and hydrocarbon resin until all parts are fully solubilized in the VOC-exempt solvent.

The brazing paste may also include an atomized alloy. The atomized alloy may include Copper, Silver, Aluminum, Silicon, Boron, Nickel, Chromium, Iron, Zinc, Tin, Manganese, and/or Phosphorus. The preferred alloy is 75% Copper, 15% Tin, 5% Phosphorus, and 5% Nickel with a variation of up to 5% for each atomized alloy. Experimentation has also shown 77.22% Copper, 15.5% Tin, 5.5% Phosphorus, and 4.5% Nickel with a variation of up to 1% for each atomized alloy, to be useful as well. However, other concentrations may be viable as well. The sprayable version of the brazing paste may also be configured to have a viscosity of 6.00% to 10.00% using a T-C spindle at 5 RPM and at a temperature of 75.2° F. However, other viscosities may be produced for other purposes such as a dispensable paste.

These and other aspects and objects of the present invention will be better appreciated and understood when considered in conjunction with the following description and the accompanying drawings. it should be understood, however, that the following description, while indicating preferred embodiments of the present invention, is given by way of illustration and not of limitation. Many changes and modifications may be made within the scope of the present invention without departing from the spirit thereof, and the invention includes all such modifications.

### BRIEF DESCRIPTION OF THE DRAWINGS

A clear conception of the advantages and features constituting the present invention, and of the construction and operation of typical mechanisms provided with the present invention, will become more readily apparent by referring to the exemplary, and therefore non-limiting, embodiments illustrated in the drawings accompanying and forming a part of this specification, wherein like reference numerals designate the same elements in the several views, and in which:

FIG. 1 shows a block diagram of the ingredients that may form the brazing binder system;

FIG. 2 shows a brazing paste including the brazing binder system of FIG. 1; and

FIG. 3 shows a block diagram of steps to produce a brazing paste such as the brazing binder system of FIG. 1.

In describing the preferred embodiment of the invention which is illustrated in the drawings, specific terminology will be resorted to for the sake of clarity, However, it is not intended that the invention be limited to the specific terms so selected and it is to be understood that each specific term includes all technical equivalents which operate in a similar manner to accomplish a similar purpose.

### DETAILED DESCRIPTION OF EMBODIMENTS

The present invention and the various features and advantageous details thereof are explained more fully with reference to the non-limiting embodiments described in detail in the following description.

### 1. Resume

The brazing binder system, which may be used in any brazing operation, is particularly advantageous in heat exchanger manufacturing. Brazing is commonly used to produce aluminum, stainless steel, nickel, copper, or any other alloy heat exchanges.

Aluminum heat exchangers, which are suitable for standard and light duty applications, fail in demanding environments such as extreme temperatures, humidity, vibration, and salty corrosive air. In these environments, the additional tensile strength, durability, and corrosion resistance that the invention provides is beneficial and provides for longer service life of the heat exchanger. The invention may be practiced, but are not limited to, brazing heat exchangers for any application. The invention may be used to replace soldered copper/brass plate fins, soldered copper brass serpentine fins, and brazed aluminum serpentine fins in extreme environment applications.

The mention may be used in a unique way such that instead of soldering to join copper and brass radiator components, the inventive binder system may be used with a number of fluxes to braze heat exchangers. Heat exchangers made with the inventive binder system are formed using anneal-resistant copper and brass alloys. The tubes may be fabricated from a brass strip and coated with a brazing filler material in the form of a powder-based paste, or an amorphous brazing foil is laid between the tube and the fin. There is another method of coating the tube in-line on the tube mill. This is done using the twin wire-arc spray process where the wire is the braze alloy, deposited on the tube as it is being manufactured at 200-400 fpm. This saves one process step of coating the tube later. The coated tubes, along with copper fins, headers, and side supports made of brass, are fitted together into a core assembly which is brazed in a furnace. The technology enables brazed serpentine fins to be used in copper-brass heat exchanger designs. They are stronger, lighter, more durable, and have tougher joints than those achieved with soldering or other manufacturing processes.

By blending a brazing alloy (such as a Cu, P, Sn, and Ni alloy) with any number of propriety binder systems (and in some cases other blended alloys), the inventive binder system produces superior products designed especially for use with various brazing processes. Under the trade name “Cupro-Flo™”, a proprietary series of brazing materials suitable for all the joint configurations commonly found in heat transfer equipment may be found. The “Cupro-Flo™” product name is used herein interchangeably with “ultra low VOC coating”, “low VOC coating”, and “VOC-free brazing paste”. Cupro-Flo™ materials may be sprayed on, brushed on, or applied using standard paste-dispensing equipment. While Cupro-Flo™ materials melt between 1100 and 1160 Fahrenheit, brazing temperature should not exceed 1260 Fahrenheit.

Cupro-Flo™ products exhibit the following advantages: low melting alloy which produces high strength joints, a clean burning binder system, elimination of wax in product, reduced drying times, dries hard, increased resistance to scratching, and ships ready-to-use by eliminating mixing components, and lastly includes an increased shelf life.

### 2. Detailed Description of Preferred Embodiments

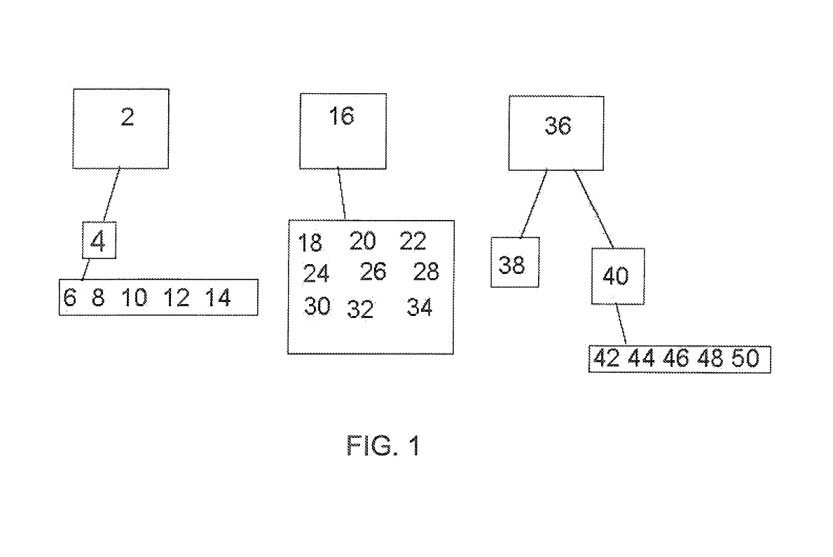

Referring to FIG. 1, the VOC exempt coatings 2 are formulated with the use of VOC exempt solvents 4. The solvents preferably include parachlorobenzotrifluoride (PCBTF) 6, tertiary butyl acetate (TBAc) 8, dimethyl carbonate (DMC) 10, methylacetate 12, and acetone 14. The VOC exempt solvents 4 may also include any combination of the following in Table 1, however chlorinated and fluorinated solvents have shown to be particularly useful. As mentioned above, PCBTF 6 are the preferred solvents:

### Table 1

methane
ethane
methylene chloride (dichloromethane)
1,1,1-trichloroethane (methyl chloroform)
1,1,2-trichloro-1,2,2-trifluoroethane (CFC-113)
trichlorofluoromethane (CFC-11)
dichlorodifluoromethane (CFC-12)
chlorodifluoromethane (HCFC-22)
trifluoromethane (HFC-23)
1,2-dichloro 1,1,2,2-tetrafluoroethane (CFC-114)
chloropentafluoroethane (CFC-115)
1,1,1-trifluoro 2,2-dichloroethane (HCFC-123)
1,2-tetrafluoroethane (HCFC-134a)
1,1-dichloro-1-fluoroethane (HCFC-141 b)
1-chloro-1,1-difluoroethane (HCFC-142b)
2-chloro-1,1,1,2-tetrafluoroethane (HCFC-124)
pentafluoroethane (HFC-12S)
1,1,2,2-tetrafluoroethane (HFC-134)
1,1,1-trifluuoroethane (HFC-143a)
1,1-difluoroethane (HFC-1S2a)
parachlorobenzotrifluoride (PCBTF)
cyclic, branched, or linear completely methylated siloxanes
acetone
perchloroethylene (tetrachloroethylene)
3,3-dichloro-1,1,1,2,2-pentafluoropropane (HCFC-22Sca)
1,3-dichloro-1,1,2,2,3-pentafluoropropane (HCFC-22Scb)
1,1,1,2,3,4,4,S,S,S-decafluoropentane (HFC-43-1 Omee)
difluoromethane (HFC-32)
ethylfluoride (HFC-161)
1,1,1,3,3,3-hexafluoropropane (HFC-236fa)
1,1,2,2,3-pentafluoropropane (HFC-24Sca)
1,1,2,3,3-pentafluoropropane (HFC-24Sea)
1,2,3-pentafluoropropane (HFC-24Seb)
1,1,1,3,3-pentafluoropropane (HFC-24Sfa)
1,1,1,2,3,3-hexafluoropropane (HFC-236ea)
1,1,1,3,3-pentafluorobutane (HFC-36S-mfc)
chlorofluoromethane (HCFC-31)
1-chloro-1-fluoroethane (HCFC-1S1a)
1,2-dichloro-1,1,2-trifluoroethane (HCFC-123a)
1,1,1,2,2,3,3,4,4-nonafluoro-4-methoxy-butane (C₄F₉OCH₃)
2-(difluoromethoxymethyl)-1,1,1,2,3,3,3-heptafluoropropane ((CF₃)₂CFCF₂OCH₃)
1-ethoxy-1,1,2,2,3,3,4,4,4-nonafluorobutane (C₄F₉OC₂H₅)
2-(ethoxydifluoromethyl)-1,1,1,2,3,3,3-heptafluoropropane ((CF₃)₂CFCF₂OC₂H₅)
methyl acetate
and perfluorocarbon compounds which fall into these classes:
(i.) Cyclic, branched, or linear, completely fluorinated alkanes
(ii.) Cyclic, branched, or linear, completely fluorinated ethers with no unsaturations
(iii.) Cyclic, branched, or linear, completely fluorinated tertiary amines with no unsaturations
(iv.) Sulfur containing perfluorocarbons with no unsaturations and with sulfur bonds only to carbon and fluourine.

The typical processing time associated with preparing the VOC exempt coatings 2 are significantly reduced due to faster drying of VOC exempt solvents 4 versus slower evaporation solvents such as aliphatic hydrocarbons.

Similarly, the usual carbon residue that forms when brazing with typical brazing pastes is reduced, or even eliminated, by utilizing polymers such as, but not limited to, styrene ethylene ethylene propylene styrene polymer or “SEEPS” 16. Some examples of SEEPS include materials sold under the trade name “Septon™” 18 which is available under the following part numbers 4044, 4033, 4055, 4077, and 4099. Other functional chemicals to reduce carbon residue may include styrene ethylene propylene, “SEP” 20 sold under the trade name “Septon™” products with associated part number 1020. C5 fully hydrogenated hydrocarbon resin 22 may also be used to reduce carbon residue wherein Mₙ≦1,200 commonly referred to in the industry under the trade names Wingtack® ten 24, Wingtack® eighty six 26, RegalRez™ 1126 28, or the like. Finally, other chemicals that achieve similar results may include styrene ethylene butylenes styrene (SEBS) 30, Styrene ethylene propylene styrene (SEPS) 32, and Styrene ethylene ethylene propylene styrene hydroxyl (SEEPS-OH) terminated polymers 34.

Another improvement of the ultra low VOC coatings 2 includes an increased suspension of alloy particles 36 through the use of high molecular weight polymers such as SEEPS polymers 38; thus, the uniformity of coating is improved.

Preferably, the VOC exempt coating 2, includes an atomized alloy powder 40. The atomized alloy powder 40 may be formed with 75% copper 42, 15% Tin 44, 5% phosphorus 46, 5% nickel 48, and −200 mesh powder 50, with a variation of up to 5% for each atomized alloy. Testing has also shown 77.22% copper 42, 15.5% Tin 44, 5.5% phosphorus 46, 4.5% nickel 48, and −200 mesh powder 50 to be advantageous as well

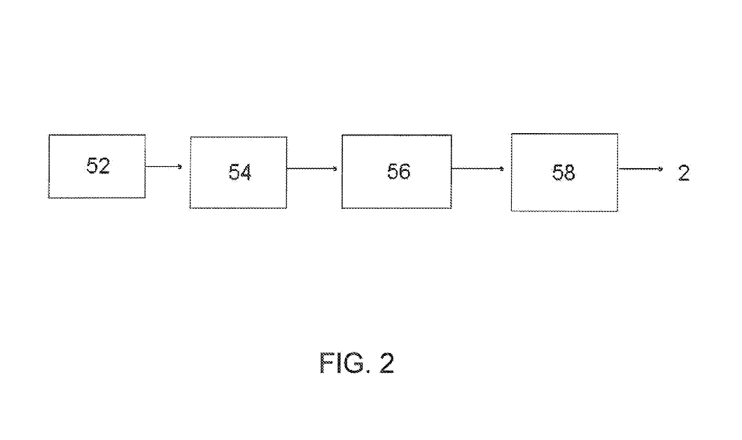

Referring now to the brazing process described earlier with respect to Cupro-Flo™ products, and also as shown in FIG. 2, the preferable steps used to make the ultra low VOC coating 2 is described as follows. While the steps are shown in FIG. 2 in the preferred order, each step may be done in any desired order to achieve a usable VOC coating 2. Preferably, a Volatile Organic Compound “VOC” exempt solvent 4, which may include a parachlorobenzotrifluoride 6, is supplied 52 that will occupy a range of 88.00% to 96,00% of the total mass of the brazing paste. A hydrogenated styrene ethylene ethylene propylene styrene/styrene ethylene propylene styrene block copolymer may then be combined 54 in a range of 3.00% to 8.00% of total mass of the final VOC coating 2. A hydrocarbon resin 22 may then be added 56 in a range of 1.00% to 4.00% of total mass of the final VOC coating 2. The hydrocarbon resin 22 is preferably produced by polymerization and hydrogenation of pure monomer hydrocarbon feedstocks. The mixture may then be mixed 58 into a homogeneous mixture to form the VOC coating 2.

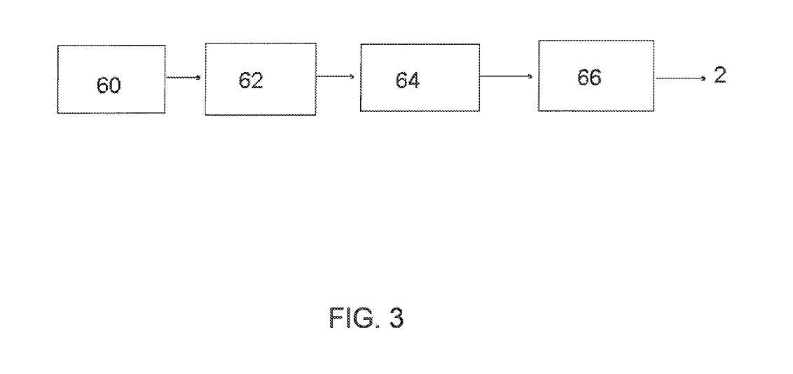

The steps described above, with respect to FIG. 2, provide an overview of the necessary ingredients to prepare the VOC coating 2, and a broad description of the steps to combine the same. The following steps shown in FIG. 3 describe in further detail how the ingredients are preferably combined with one another. Preferably the VOC coating 2, and optionally the parachlorobenzotrifluoride 6, is mixed in a homogeneous mixture 58 by adding the VOC-exempt solvent 4 into to an impermeable container and Cowles blade 60. While many other containers and mixing devices may be used, an impermeable container prevents the VOC exempt solvent 4 from dissolving the mixing bowl. Cowles blades also effectively churn the mixture for faster mixing times.

Next, the hydrogenated styrene ethylene ethylene propylene styrene/styrene ethylene propylene styrene block copolymer may be added 62 to the impermeable container and the mixture may be mixed with the Cowles blade 64 for a period of time while adding the hydrocarbon resin 22 to the impermeable container while continuing to mix until the hydrogenated styrene ethylene ethylene propylene styrene/styrene ethylene propylene styrene block copolymer and hydrocarbon resin are fully solubilized in the VOC exempt solvent, thus producing the final VOC coating 2.

Also, the VOC coating 2 may include an atomized alloy powder 40, that is mixed in the impermeable container, 66 that preferably is formulated of 75% copper 42, 15% Tin 44, 5% phosphorus 46, 5% nickel 48, and −200 mesh powder 50, with a variation of up to 5% for each atomized alloy.

Although the best mode contemplated by the inventors of carrying out the present invention is disclosed above, practice of the present invention is not limited thereto. It will be manifest that various additions, modifications, and rearrangements of the features of the present invention may be made without deviating from the spirit and scope of the underlying inventive concept.

Moreover, the individual components need not be formed in the disclosed shapes, or assembled in the disclosed configuration, but could be provided in virtually any shape and assembled in virtually any configuration. Furthermore, all the disclosed features of each disclosed embodiment can be combined with, or substituted for, the disclosed features of every other disclosed embodiment except where such features are mutually exclusive.

It is intended that the appended claims cover all such additions, modifications, and rearrangements. Expedient embodiments of the present invention are differentiated by the appended claims.

What is claimed is:

1. A method of forming a binder system comprising the steps of:
A. providing a Volatile Organic Compound “VOC” exempt solvent in a range of 88.00% to 96.00% of total mass of the brazing paste;
B. combining one of a 1) hydrogenated styrene ethylene ethylene propylene styrene/styrene ethylene propylene styrene block copolymer, 2) styrene ethylene butylene styrene, 3) styrene ethylene propylene styrene, and 4) styrene ethylene ethylene propylene styrene hydroxyl terminated polymers in a range of 3.00% to 8.00% of total mass of the brazing paste;
C. adding a hydrocarbon resin in a range of 1.00% to 4.00% of total mass of the brazing binder system; and
D. mixing the brazing binder system into a homogeneous mixture.

2. The method of forming a brazing binder system of claim 1, wherein the VOC exempt solvent includes at least one solvent.

3. The method of forming a brazing binder system of claim 1, wherein the hydrogenated styrene ethylene ethylene propylene styrene/styrene ethylene propylene styrene block copolymer includes block segments of styrene monomer units and hydrogenated conjugated diene monomer units.

4. The method of forming a brazing binder system of claim 1, wherein the hydrogenated styrene ethylene ethylene propylene styrene/styrene ethylene propylene styrene block copolymer includes a styrene content of at least 18% weight.

5. The method of forming a brazing binder system of claim 1, wherein the hydrocarbon resin is produced by polymerization and hydrogenation of pure monomer hydrocarbon feedstocks.

6. The method of forming a brazing binder system of claim 1, wherein the steps further comprise:
A. mixing the brazing binder system into a homogeneous mixture includes adding the VOC-exempt solvent into to an impermeable container and Cowles blade;
B. adding at least one of one of a 1) hydrogenated styrene ethylene ethylene propylene styrene/styrene ethylene propylene styrene block copolymer, 2) styrene ethylene butylene styrene, 3) styrene ethylene propylene styrene, and 4) styrene ethylene ethylene propylene styrene hydroxyl terminated polymers to the impermeable container;
C. continuing to mix with the Cowles blade; and
D. adding the hydrocarbon resin to the impermeable container while continuing to mix until the hydrogenated styrene ethylene ethylene propylene styrene/styrene ethylene propylene styrene block copolymer and hydrocarbon resin are fully solubilized in the VOC-exempt solvent.

7. The method of forming a brazing binder system of claim 6, wherein the brazing binder system includes an atomized alloy.

8. The method of forming a brazing binder system of claim 7, wherein the atomized alloy includes copper, tin, phosphorus, boron, aluminum, silicon, iron, zinc, manganese, cobalt, and/or nickel.

9. A brazing binder system comprising:
88.00% to 96.00% weight of a VOC-exempt solvent in a range of
3.00% to 8.00% weight of a hydrogenated styrene ethylene ethylene propylene styrene/styrene ethylene propylene styrene block copolymer; and a
1.00% to 4.00% weight of a hydrocarbon resin.

10. The brazing binder system of claim 9, wherein the VOC-exempt solvent is methane.

11. The brazing binder system of claim 9, wherein the hydrogenated styrene ethylene ethylene propylene styrene/styrene ethylene propylene styrene block copolymer includes block segments of styrene monomer units and hydrogenated conjugated diene monomer units.

12. The brazing binder system of claim 9, wherein the hydrogenated styrene ethylene ethylene propylene styrene/styrene ethylene propylene styrene block copolymer includes a styrene content of at least 18% weight.

13. The brazing binder system of claim 9, wherein the hydrocarbon resin is produced by polymerization and hydrogenation of pure monomer hydrocarbon feedstocks.

14. The brazing binder system of claim 9, wherein the brazing binder system includes an atomized alloy.

15. The brazing binder system of claim 9, wherein the atomized alloy includes at least one of copper, tin, phosphorus, boron, aluminum, silicon, iron, zinc, manganese, cobalt, and nickel.

16. A brazing binder system comprising:
A. a VOC-exempt solvent including parachlorobenzotrifluoride;
B. a hydrogenated styrene ethylene ethylene propylene styrene/styrene ethylene propylene styrene block copolymer including block segments of styrene monomer units and hydrogenated conjugated diene monomer units; and
C. a hydrocarbon resin including polymerized and hydrogenated pure monomer hydrocarbon feedstocks.

17. The brazing binder system of claim 16, further comprising:
the VOC-exempt solvent is provided in a range of 88.00% to 96.00% of total mass;
the hydrogenated styrene ethylene ethylene propylene styrene/styrene ethylene propylene styrene block copolymer is provided in a range of 3.00% to 8.00% of total mass; and
the hydrocarbon resin is provided in a range of 1.00% to 4.00% of total mass.

18. The brazing binder system of claim 16, further comprising an atomized alloy wherein the atomized alloy includes at least one of copper, tin, phosphorus, boron, aluminum, silicon, iron, zinc, manganese, cobalt, and nickel.

19. The brazing binder system of claim 16, wherein hydrogenated styrene ethylene ethylene propylene styrene/styrene ethylene propylene styrene block copolymer and hydrocarbon resin are fully solubilized in the VOC-exempt solvent.

20. The brazing binder system of claim 16, wherein a sprayable version of the brazing binder system is configured to include a viscosity of 6.00% to 10.00% using a T-C spindle at 5 RPM and at a temperature of 75.2° F.
